(19) United States
(12) Patent Application Publication
(10) Pub. No.: US 2026/0009414 A1
(43) Pub. Date: Jan. 8, 2026

(54) COMPONENT FASTENING STRUCTURE

(71) Applicant: TOYOTA JIDOSHA KABUSHIKI KAISHA, Toyota-shi (JP)

(72) Inventors: Shotaro KUROKAWA, Nisshin-shi (JP); Jun Hayase, Okazaki-shi (JP); Kiyoto Mori, Toyota-shi (JP)

(73) Assignee: TOYOTA JIDOSHA KABUSHIKI KAISHA, Toyota-shi (JP)

(21) Appl. No.: 19/083,601

(22) Filed: Mar. 19, 2025

(30) Foreign Application Priority Data
Jul. 4, 2024 (JP) 2024-108466

(51) Int. Cl. F16B 5/02; F16B 1/00

(52) U.S. Cl. CPC F16B 5/0208; F16B 1/00

(57) ABSTRACT

A first component having a first fastening portion, and a second component having a second fastening portion to be bonded and fastened to the first fastening portion, wherein the first fastening portion has a first fastening surface, the second fastening portion has a second fastening surface facing the first fastening surface, and the second fastening surface has a parallel area parallel to the first fastening surface and in contact with the first fastening surface, and an inclined area inclined with respect to the first fastening surface, and the second fastening portion is fastened to the first fastening portion in the parallel area.

### CROSS-REFERENCE TO RELATED APPLICATION

This application claims priority to Japanese Patent Application No. 2024-108466 filed on Jul. 4, 2024. The disclosure of the above-identified application, including the specification, drawings, and claims, is incorporated by reference herein in its entirety.

### BACKGROUND

### 1. Technical Field

The present specification discloses a component fastening structure in which a second component is fastened and bonded to a first component.

### 2. Description of Related Art

Conventionally, there has been disclosed a technique of fastening and bonding two components to each other in order to firmly couple the two components. For example, there is known a technique in which a first component is fastened to a second component by bolts in a state in which an adhesive is provided between the first component and the second component. However, when the two components are simply bolted to each other in a state of being in close contact with each other, the adhesive between the two components may be pushed out. As a result, the two components cannot be bonded to each other.

Japanese Unexamined Patent Application Publication No. 11-236070 (JP 11-236070 A) discloses a technique of coupling a flange of a lower component to a flange of an upper component. In JP 11-236070 A, the lower flange is provided with a plurality of protrusions protruding toward the upper flange. With such a configuration, there remains a space in which the adhesive stays between the lower flange and the upper flange, even if the lower flange is fastened to the upper flange by bolts. As a result, the lower flange is fastened and bonded to the upper flange.

### SUMMARY

However, in the technique of JP 11-236070 A, only the distal end surfaces of the protrusions of the lower flange are in contact with the upper flange. Therefore, when the bolts are tightened, the tightening force is concentrated on the distal end surfaces of the protrusions. When the tightening force is concentrated in a small area such as the distal end surfaces of the protrusions, the upper flange may be broken. Then, in the case of the technique of JP 11-236070 A, in order to suppress such breakage, the bolt tightening force may not be sufficiently increased, and the two components may not be firmly fastened to each other.

Thus, the present specification discloses a component fastening structure capable of firmly fastening two components to each other.

An aspect of the present specification discloses a structure including: first component including a first fastening portion; and a second component including a second fastening portion to be bonded and fastened to the first fastening portion, in which: the first fastening portion has a first fastening surface; the second fastening portion has a second fastening surface facing the first fastening surface; the second fastening surface includes a parallel area parallel to the first fastening surface and in contact with the first fastening surface, and an inclined area inclined with respect to the first fastening surface; and the second fastening portion is fastened to the first fastening portion in the parallel area.

In this case, the first component and the second component may be assembled in a state in which the first component and the second component are not relatively movable in a direction orthogonal to the first fastening surface even if fastening and bonding between the first fastening portion and the second fastening portion are released.

In addition, the inclined area may be inclined in a direction in which a gap from the first fastening surface increases toward a downstream side in an assembly direction of the second component; and the inclined area and the parallel area may be arranged in a direction intersecting the assembly direction.

In addition, the first component may be a rocker extending in a vehicle front-rear direction; the second component may be a cast component in which a pair of right and left suspension towers are integrally molded; and the cast component may include two second fastening portions fastened to each of a pair of right and left rockers.

According to the technique disclosed herein, the second fastening surface is provided with both the parallel area and the inclined area. This ensures both a large surface to receive the fastening pressure and a gap in which the adhesive stays. As a result, the second component can be firmly fastened and bonded to the first component.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a component to be fastened;

FIG. 2 is a schematic view showing a state in which a cast component is assembled to a rocker;

FIG. 3 is a perspective view of the second fastening portion with a portion of the second fastening portion broken;

FIG. 4 is a cross-sectional view in a parallel area;

FIG. 5 is a cross-sectional view in an inclined area; and

FIG. 6 is a schematic view showing a state of component fastening of a comparative example.

### DETAILED DESCRIPTION OF EMBODIMENTS

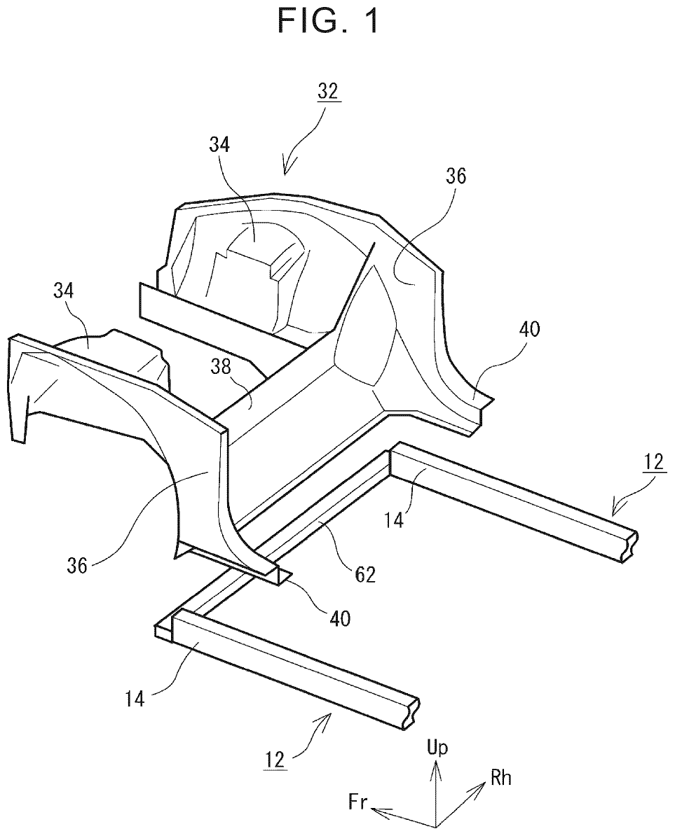

Hereinafter, a fastening structure of a component will be described with reference to the drawings. FIG. 1 is a diagram illustrating an example of a component to be fastened. Fr, Up, Rh in the drawings indicate the front, upper, and right sides of the vehicles, respectively.

In the present specification, a case where the cast component 32 is fastened to the rocker 12 will be described as an example. The rocker 12 is a skeleton member extending in the front-rear direction of the vehicle. As shown in FIG. 1, in a vehicle, two rockers 12 are arranged in parallel with each other with a space therebetween in the vehicle width direction. The distance between the two rockers 12 is fixed by the cross frame 62. The cross frame 62 is a skeleton member extending in the vehicle width direction. The cross frame 62 is joined to the two rockers 12 at the axial end of the rocker 12. Although only one cross frame 62 is shown in FIG. 1, actually, two cross frames 62 are provided one at each of both axial ends of the rocker 12. The two rockers 12 and the two cross frames 62 are then combined with each other to form a rectangle.

The cast component 32 is a cast molded product made of a light metal such as aluminum. In the example of FIG. 1, the cast component 32 is a large cast molded article called gigacast or megacast. The cast component 32 includes a pair of right and left suspension towers 34, a pair of right and left side panels 36, and a connection panel 38. The side panel 36 is a panel portion extending from the suspension tower 34 toward the rear of the vehicle. The side panel 36 constitutes a part of the side wall of the vehicle cabin. The connection panel 38 connects the pair of right and left side panels 36. A dash panel (not shown) separating the vehicle cabin and the power unit compartment is joined to the connection panel 38.

Here, as shown in FIG. 1, the rear end of the side panel 36 is bent in a stepped manner so as to follow the shape of the rocker 12. This stepped portion is joined and adhered to the rocker 12. Therefore, in the example shown in FIG. 1, the rocker 12 functions as the first component 10, and the cast component 32 functions as the second component 30. In addition, the stepped portion of the cast component 32 is the second fastening portion 40, and a portion of the rocker 12 on which the stepped portion (the second fastening portion 40) is placed is the first fastening portion 14. In the following description, the rocker 12 is referred to as a “first component 10” and the cast component 32 is referred to as a “second component 30” as necessary. In FIG. 1, only the cast component 32 disposed on the front side of the vehicle is illustrated, but a cast component similar to the cast component 32 is also disposed on the rear side of the vehicle and coupled to the rocker 12.

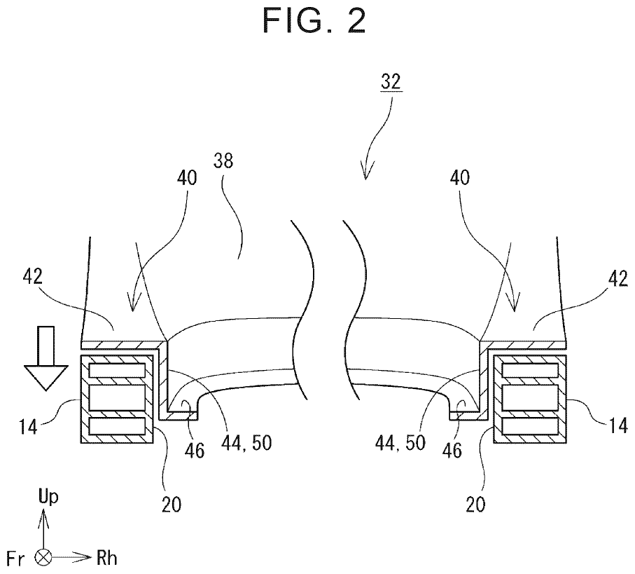

FIG. 2 is a schematic view showing a state in which the cast component 32 is assembled to the rocker 12. As shown in FIG. 2, and as described above, the second fastening portion 40 of the cast component 32 is substantially stepped. More specifically, the second fastening portion 40 includes a top wall 42, a side wall 44 extending downward from an inner end portion of the top wall 42, and a flange 46 extending inward in the vehicle width direction from a lower end of the side wall 44. When the cast component 32 is assembled to the rocker 12, the cast component 32 is arranged such that the top wall 42 is along the upper surface of the rocker 12 and the side wall 44 is along the inner end surface of the rocker 12. The side wall 44 of the cast component 32 is screwed and fastened to the inner end surface of the rocker 12. Hereinafter, the inner end surface of the rocker 12 is referred to as a “first fastening surface 20”, and the side wall 44 fastened to the first fastening surface 20 is referred to as a “second fastening surface 50”.

Here, the pair of right and left rockers 12, because it is connected by a cross frame 62, the vehicle width direction spacing of the pair of right and left first fastening portion 14 is fixed. Further, since the pair of right and left second fastening portions 40 is connected by the connection panel 38, the vehicle width direction interval between the pair of right and left second fastening portions 40 is also fixed. Therefore, when the cast component 32 is assembled to the rocker 12, the cast component 32 needs to be inserted from above to below the rocker 12 (that is, in a direction parallel to the first fastening surface 20). In other words, the cast component 32, even in a state in which the fastening and adhesion is released, in a state that cannot be relatively moved in a direction perpendicular to the first fastening surface 20 (i.e. the vehicle width direction), it is assembled to the rocker 12. Then, in a state in which the cast component 32 is assembled to the rocker 12, the cast component 32 is fastened and bonded to the rocker 12.

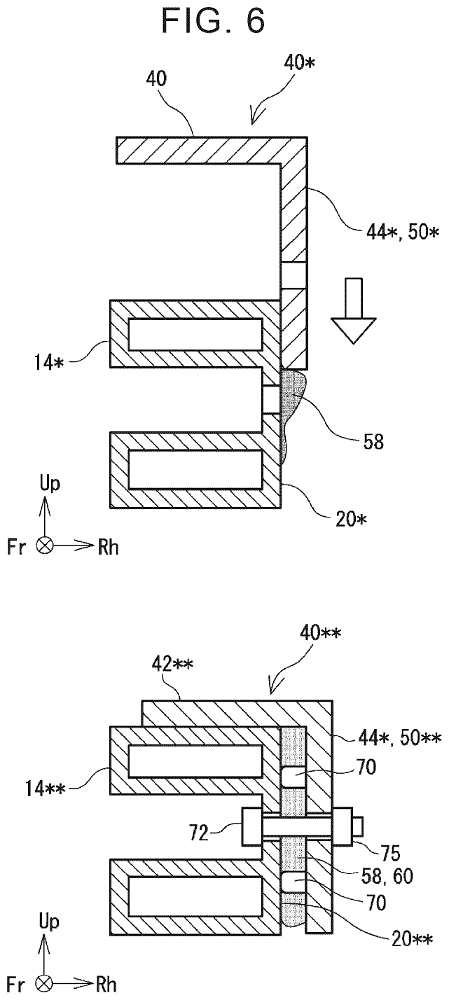

Incidentally, when the second component 30 is moved in a direction parallel to the first fastening surface 20 and is assembled to the first component 10, there is a possibility that the second component 30 cannot be properly bonded to the first component 10. This will be described with reference to FIG. 6.

In order to adhere the second fastening surface 50 to the first fastening surface 20, an adhesive 58 is typically applied to the first fastening surface 20 prior to assembly of the cast component 32. Further, as described above, the cast component 32 is moved in a direction parallel to the first fastening surface 20 of the rocker 12, and is assembled to the rocker 12. The upper part of FIG. 6 is a schematic view showing how the conventional cast component 32* is fastened to the first fastening portion 14*. Typically, the second fastening surface 50* provided on the cast component 32* is parallel to the first fastening surface 20*. In this case, in the process of assembling the cast component 32*, the adhesive 58 applied to the first fastening surface 20* may be scraped off by the second fastening surface 50*. Thus, there is a possibility that almost no adhesive 58 remains between the first fastening surface 20* and the second fastening surface 50*, and the first fastening surface 20* and the second fastening surface 50* are not sufficiently bonded.

In order to avoid such an issue, it is conceivable to provide, in part, a protrusion 70 protruding toward the first fastening surface 20** on the second fastening surface 50 as shown in the lower part of FIG. 6. Here, the protrusion 70 is interposed between the first fastening surface 20** and the second fastening surface 50**. As a result, a gap 60 in which the adhesive 58 can stay is formed between the first fastening surface 20** and the second fastening surface 50**. Then, the first fastening surface 20** and the second fastening surface 50** are appropriately adhered to each other by the adhesive 58.

However, most of the second fastening surface 50** is separated from the first fastening surface 20**, and only the distal end surface of the protrusion 70 contacts the first fastening surface 20**. When the fastening bolt 72 is fastened, the stresses associated with the fastening are concentrated at the points where the protrusion 70 contacts the first fastening surface 20**. Due to such concentrated stresses, deformation and breakage of the first component 10** and the second component 30** may occur. In order to suppress such deformation and breakage, the fastening force of the fastening bolt 72 may be weakened, but the fastening force of the first component 10** and the second component 30** is naturally weakened.

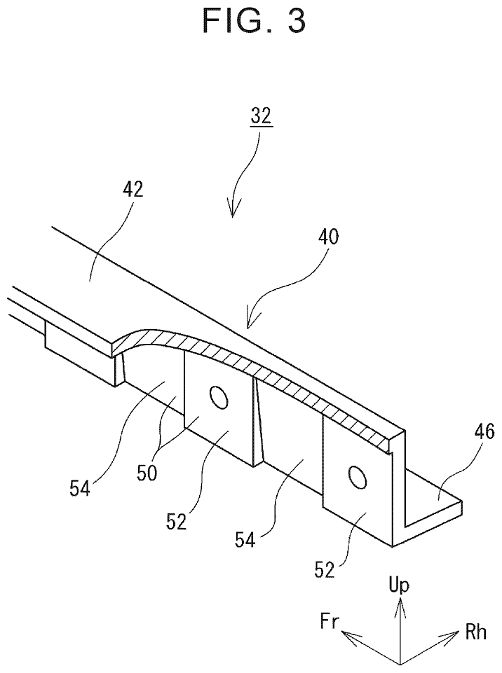

In order to avoid such a problem, in the example, a part of the second fastening surface 50 is inclined with respect to the first fastening surface 20. This will be described below. FIG. 3 is a perspective view of the second fastening portion 40 in a state in which a part of the second fastening portion 40 is broken. As described above, the side wall 44 of the second fastening portion 40 functions as the second fastening surface 50 facing the first fastening surface 20 of the rocker 12. In the present example, the second fastening surface 50 is provided with a parallel area 52 and an inclined area 54.

The parallel area 52 is an area parallel to the first fastening surface 20. A female screw 56 to which a fastening bolt (not shown) is screwed is formed in the parallel area 52. The inclined area 54 is an area inclined with respect to the first fastening surface 20. More specifically, the inclined area 54 is inclined in a direction away from the first fastening surface 20 as it approaches the lower end, that is, as it approaches the downstream side in the assembling direction. On the second fastening surface 50, the parallel area 52 and the inclined area 54 are alternately arranged in a direction intersecting the assembling direction (that is, the vehicle front-rear direction).

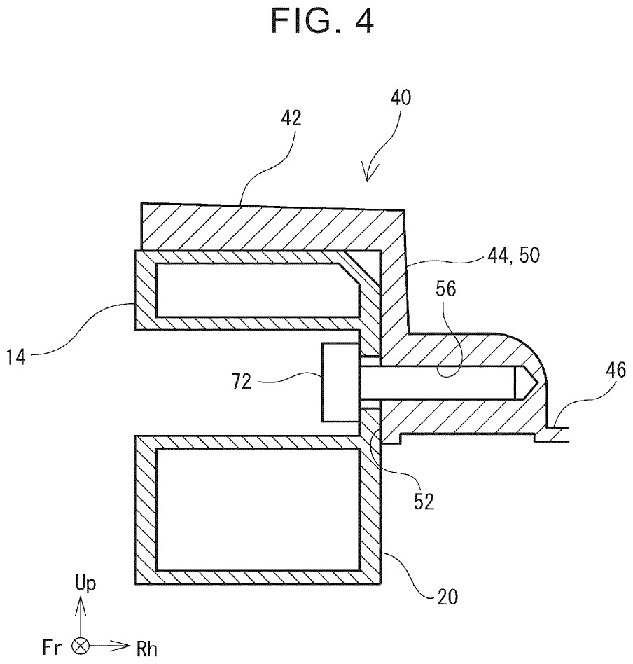

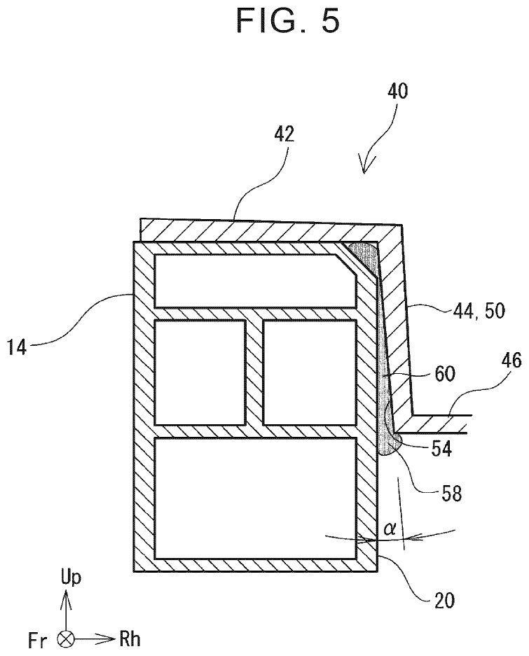

FIG. 4 is a cross-sectional view of the parallel area 52, and FIG. 5 is a cross-sectional view of the inclined area 54. As shown in FIG. 4, since the parallel area 52 is parallel to the first fastening surface 20, the entire surface of the parallel area 52 is in contact with the first fastening surface 20. In this state, the first fastening surface 20 is fastened to the parallel area 52 with fastening bolts 72. Since the stress generated by the fastening is received over the entire surface of the parallel area 52, the concentration of the stress is unlikely to occur. Therefore, even if the fastening bolt 72 is tightened strongly, deformation and breakage of the first component 10 and the second component 30 do not occur. As a result, the second component 30 can be firmly fastened to the first component 10. In FIG. 4, a female screw 56 for receiving the fastening bolt 72 is formed behind the second fastening surface 50. However, as in the lower stage of FIG. 6, only the insertion hole of the fastening bolt 72 may be formed in the second fastening surface 50. In this case, the first component 10 and the second component 30 are fastened by the fastening bolt 72 and the nut 75.

On the other hand, as shown in FIG. 5, the inclined area 54 is inclined with respect to the first fastening surface 20. In this case, even if the second component 30 is moved from the top to the bottom, the adhesive 58 previously applied to the first fastening surface 20 is not scraped off by the inclined area 54. Even in a state where the second component 30 is pressed to the lowermost position, a gap 60 in which the adhesive 58 stays is formed between the first fastening surface 20 and the inclined area 54. The first fastening surface 20 and the inclined area 54 are firmly adhered to each other by the adhesive 58.

Incidentally, the inclination angle α of the inclined area 54 with respect to the first fastening surface 20 is not particularly limited as long as the gap 60 in which the adhesive 58 can stay can be secured. For example, the inclination angle α is 0.5 degrees or more and 5 degrees or less. In the illustrated example, the inclined area 54 is continuously inclined from the upper end to the lower end of the second fastening surface 50 (that is, from the upstream end to the downstream end in the assembling direction). However, the inclined area 54 may be provided only in a part of the first fastening surface 20 in the height direction.

As is apparent from the above description, in the present example, both the parallel area 52 and the inclined area 54 are provided on the second fastening surface 50. As a result, it is possible to secure both the large surface subjected to the fastening pressure and the gap 60 in which the adhesive 58 stays, and thus it is possible to firmly fasten and adhere the second component 30 to the first component 10. The second fastening portion 40 has a complicated shape having a parallel area 52 and an inclined area 54. It is often difficult to form such shapes by extrusion or milling. In the present example, the second component 30 having the second fastening portion 40 is a cast component 32 formed by casting. Therefore, a complicated shape having the parallel area 52 and the inclined area 54 can be easily formed.

Note that the configuration described above is merely an example, and other configurations may be changed as appropriate as long as the configuration described in claim 1 is provided. For example, the above description exemplifies the case where the rocker 12 is the first component 10 and the cast component 32 is the second component 30. However, the first component 10 and the second component 30 may be other parts as long as they are fastened and bonded. Therefore, the technology disclosed in the present specification can be used not only for fastening on-vehicle components but also for fastening various components. For example, in the above-described example, the assembly direction of the second component 30 is limited to the vehicle up-down direction. However, the techniques disclosed herein are not limited to components with limited assembly directions. Further, in the above description, the second component 30 (that is, the cast component 32) has two second fastening portions 40, but the second fastening portions 40 included in the second component 30 may be one or three or more.

Further, in the above-described example, the plurality of parallel areas 52 and the plurality of inclined areas 54 are arranged alternately, but the arrangement and the number of the parallel areas 52 and the inclined areas 54 may be changed as appropriate. Thus, for example, the number of the parallel areas 52 and the inclined areas 54 may be one. Reducing the number of parallel areas 52 and inclined areas 54 simplifies the shape of the second component 30 and facilitates the shaping of the second component 30. When a plurality of parallel areas 52 and inclined areas 54 are provided and the parallel areas 52 and the inclined areas 54 are alternately arranged, the adhesive force and the fastening force are evenly distributed, so that the second component 30 can be fastened more stably to the first component 10.

In addition, the parallel area 52 and the inclined area 54 may be arranged not in the vehicle front-rear direction but in the up-down direction (that is, the assembling direction of the second component 30). For example, the upper half of the second fastening surface 50 may be the parallel area 52, and the lower half may be the inclined area 54.

What is claimed is:

1. A component fastening structure comprising:
a first component including a first fastening portion; and
a second component including a second fastening portion to be bonded and fastened to the first fastening portion, wherein:
the first fastening portion has a first fastening surface;
the second fastening portion has a second fastening surface facing the first fastening surface;
the second fastening surface includes
a parallel area parallel to the first fastening surface and in contact with the first fastening surface, and
an inclined area inclined with respect to the first fastening surface; and
the second fastening portion is fastened to the first fastening portion in the parallel area.

2. The component fastening structure according to claim 1, wherein the first component and the second component are assembled in a state in which the first component and the second component are not relatively movable in a direction orthogonal to the first fastening surface even if fastening and bonding between the first fastening portion and the second fastening portion are released.

3. The component fastening structure according to claim 2, wherein:
the inclined area is inclined in a direction in which a gap from the first fastening surface increases toward a downstream side in an assembly direction of the second component; and
the inclined area and the parallel area are arranged in a direction intersecting the assembly direction.

4. The component fastening structure according to claim 2, wherein the second component is a cast component.

5. The component fastening structure according to claim 3, wherein:
the first component is a rocker extending in a vehicle front-rear direction;
the second component is a cast component in which a pair of right and left suspension towers are integrally molded; and
the cast component includes two second fastening portions fastened to each of a pair of right and left rockers.
